(19) United States
(12) Patent Application Publication
(10) Pub. No.: US 2004/0202346 A1
(43) Pub. Date: Oct. 14, 2004

(54) Wall mounting speaker assembly

(75) Inventors: Seon-kyu Park, Suwon City (KR); Eun-jong Choi, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/811,893

(22) Filed: Mar. 30, 2004

(30) Foreign Application Priority Data
Apr. 8, 2003 (KR) 2003-22051

(51) Int. Cl. H04R 9/06; H04R 25/00

(52) U.S. Cl. 381/386; 381/431; 381/387

(57) ABSTRACT

A wall mounting speaker assembly having a speaker unit, includes a stationary member mounted on a wall; a supporter supporting the speaker unit; a movable joint provided between the stationary member and the supporter, and combined with a vertical swiveling shaft and a horizontal tilting shaft, which make the speaker unit swivel and tilt; a lock provided on a bottom of the speaker unit; and a hook provided on the supporter to be engaged with the lock, preventing the speaker unit form moving upward. With this configuration, the present invention provides a wall mounting speaker assembly which can mount a speaker unit with a simple and convenient setup method without a screwing work, and has swiveling and tilting functions.

### CROSS-REFERENCE TO RELATED APPLICATIONS

This application claims the benefit of Korean Patent Application No. 2003-022051, filed Apr. 8, 2003, in the Korean Intellectual Property Office, the disclosure of which is incorporated herein by reference.

### BACKGROUND OF THE INVENTION

1. Field of the Invention

The present invention relates to a wall mounting speaker assembly and, more particularly a speaker unit which can swivel and/or tilt.

2. Description of the Related Art

In general, a conventional wall mounting speaker apparatus is set on a fixed location of a wall facing an initial setup direction only. Consequently, the speaker unit emits sounds toward one direction only. It also has a limit in mounting location because the speaker requires the most suitable spot on the wall to be fixed steady.

Therefore, there have been many proposals of a wall mounting speaker which can alter its direction, but still problems have remained. For example, the speaker device, disclosed in Korean Utility Model First Publication No. 1988-3736, has a speaker unit screwed on a supporter mounted on a wall. However the screwing method disclosed in this publication is inconvenient. The speaker device disclosed in Korean Utility Model first Publication No. 1991-4241, has a similar problem. The speaker unit in this publication is screwed on a supporter and has a mounting part screwed on the backside of the speaker. Thus a whole supporting unit including the supporter and the mounting part needs to be disassembled, and the mounting part also has to be screwed off from the backside of the speaker unit in order to mount and/or demount the speaker. This mounting and/or demounting process is time consuming and inconvenient.

### SUMMARY OF THE INVENTION

Accordingly, an aspect of the present invention provides a wall mounting speaker assembly which mounts a speaker unit with a simple and convenient setup method without a screwing work, and has swiveling and tilting functions.

The forgoing and/or other aspects of the present invention are achieved by providing a wall mounting speaker assembly having a speaker unit, comprising a stationary member mounted on a wall; a supporter supporting the speaker unit; a movable joint provided between the stationary member and the supporter, and combined with a vertical swiveling shaft and a horizontal tilting shaft, allowing the speaker unit to swivel and tilt; a lock provided on a bottom of the speaker unit; and a hook provided on the supporter to be engaged with the lock, preventing the speaker unit form moving upward.

According to another aspect of the invention, the hook is engaged with the lock with the speaker unit having been slid towards the front of the supporter.

According to another aspect of the invention, the speaker assembly further comprises a stopper provided at the supporter, preventing release of the speaker unit.

According to another aspect of the invention, a stopper groove is concave at the bottom of the speaker unit to accommodate the stopper therein.

According to another aspect of the invention, a stopper through hole is formed in the supporter. The stopper includes a flat part attached to the backside of the supporter, a holding part protruding upward to penetrate the hole, and a release part forcing the stopper to move downward and to release the lock.

According to another aspect of the invention, the speaker assembly further comprises a cable clip, provided under the supporter, holding a power supply cable for the speaker unit.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a wall mounting speaker assembly according to an embodiment of the present invention;

FIG. 2 is an exploded perspective view of the wall mounting speaker assembly illustrated in FIG. 1;

FIG. 3 is a perspective view illustrating a bottom part of the speaker assembly in FIG. 1;

FIG. 4 is a sectional view of the speaker unit in a swiveling state;

FIGS. 5A and 5B are sectional views of the speaker unit in a tilting state;

FIG. 6 is a sectional view of the speaker unit after the speaker is loaded on a supporter; and

FIG. 7 is a sectional view illustrating the state in which the speaker unit is loaded on and unloaded from the supporter.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

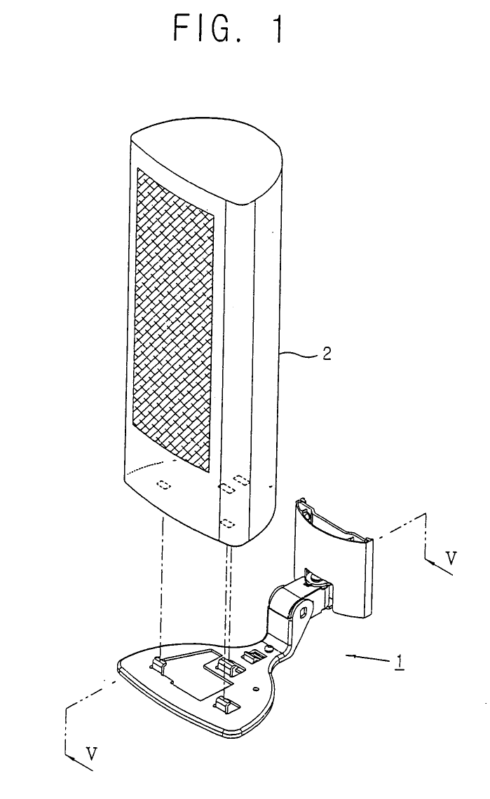

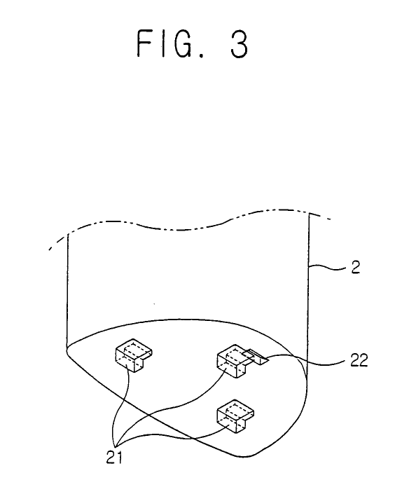

As shown in FIG. 1 to FIG. 3, a wall mounting speaker assembly according to the present invention comprises a speaker unit 2 and a speaker bracket 1. The speaker bracket 1 comprises a stationary member 11 mounted on a wall, a supporter 12 which supports the speaker unit 2, and a movable joint 13 which connects the supporter 12 with the stationary member 11 to enable the supporter 12 to swivel and tilt, and a cover 19 for the stationary member 11.

The speaker unit 2 has locks 21 protruding from a bottom surface thereof toward the supporter 12, and a groove 22 for a stopper 14 (to be described later) adjacent to the locks 21. The stationary member 11 comprises at least one swiveling bracket 111 having a hole 111a into which a swiveling shaft 132 is inserted such that the swiveling bracket 111 is coupled to the movable joint 13.

The supporter 12 is of a plate shape to place the speaker unit 2 thereon. Hooks 16 are formed on the supporter 12 to be engaged with the locks 21 at the bottom of the speaker unit 2 to hold the speaker unit 2 in place relative to the supporter 12. The supporter 12 has a hole 122 for the stopper 14. At least one tilting bracket 121 is provided at one side of the supporter 12, having a hole 121a into which a tilting shaft 133 is inserted such that the supporter 12 is coupled to the movable joint 13.

The movable joint 13 is located between the stationary member 11 and the supporter 12, and rotatably coupled to the swiveling shaft 132 and the tilting shaft 133 to enable the speaker unit 2 to be tilted and swiveled. Both shafts 132 and 133 are rotatably inserted through the holes 131a and 131b with the swiveling bracket 111 and the tilting bracket 121, respectively. Thus the shafts 132 and 133 function similar to hinge shafts.

The stopper 14 is elastic, and comprises a flat part 141 fixed on the backside of the supporter 12, a holding part 142 protruding upward and penetrating the hole of the supporter 12, and a release part 143 pulling down the holding part 142 to release the hooks 16.

The speaker unit 2 also comprises a power supply cable (not shown) and a cable clip 15, which is disposed on the backside of the flat part 141 of the stopper 14 and arranges the cable.

With this configuration, an operating process of the wall mounting type speaker assembly according to the present invention will be described as follows.

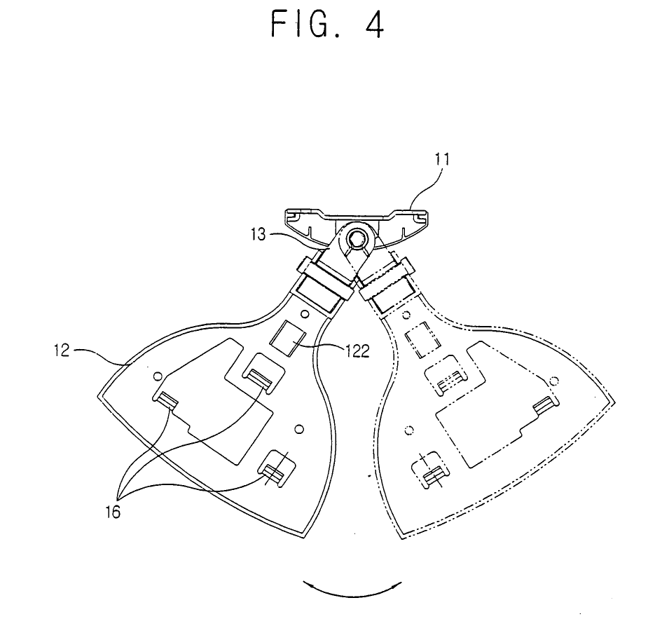

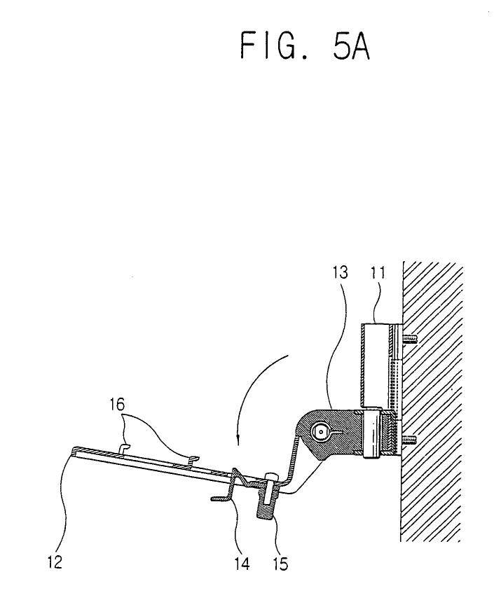

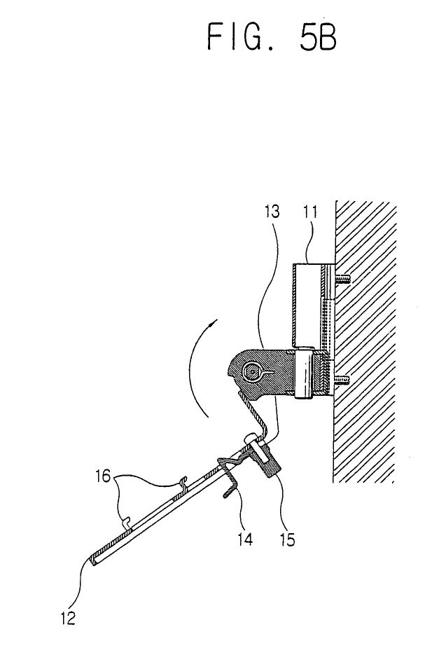

The wall mounting speaker assembly, as described above, includes the speaker unit 2 and the speaker bracket 1. The speaker bracket 1 comprises the stationary member 11, the supporter 12, and the movable joint 13. As shown in FIG. 4, FIG. 5A, and 5B, the supporter 12 can swivel about the swiveling and tilting shafts 132 and 133 inserted through the movable joint 13 to setup the position or direction of the speaker unit 2. A frictional force exists between the movable joint 13 and the swiveling and tilting shafts 132 and 133 and, as a result, a user may adjust the position or direction of the speaker unit 2 by applying a force slightly exceeding the frictional force.

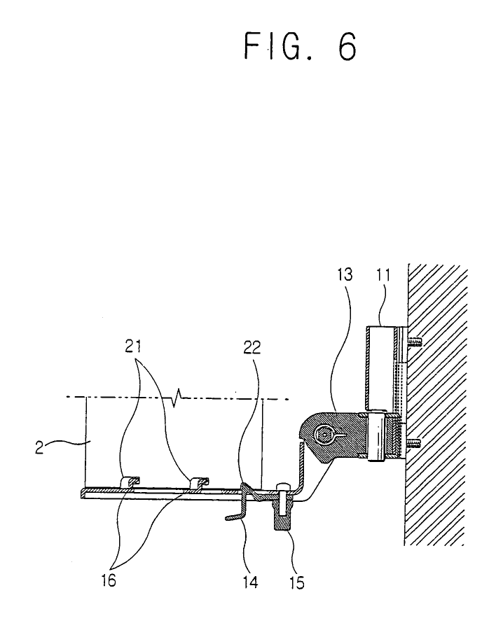

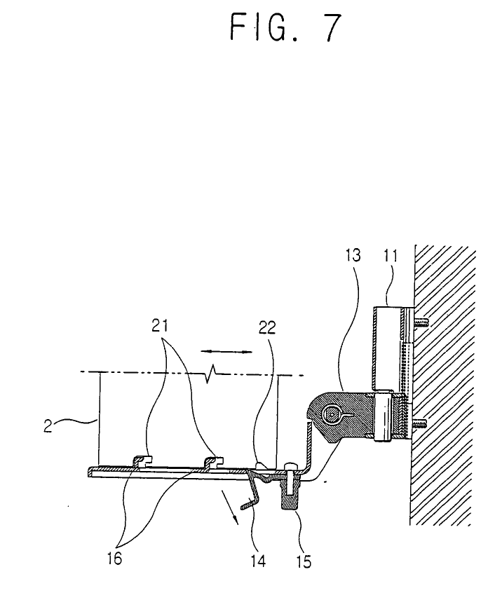

The speaker unit 2 and the supporter 12 are assembled as shown in FIG. 6 and FIG. 7. The hooks 16 of the supporter 12 are engaged into the locks 21 of the speaker unit 2 by pulling the speaker unit 2 frontward from the stationary member 11 along the supporter 12 (as shown in FIG. 7). The elastic stopper 14 penetrates the hole 122 in the supporter 12, and fits into the groove 22 on the bottom of the speaker unit 2, blocking the stopper 14 from sliding backward and/or moving from side to side.

The process of unloading the speaker unit 2 from the supporter 12 is as follows. At first, the release part 143, located on the backside of the supporter 12, is pushed down, and the stopper 14, locked in the hole 22, is released. The speaker unit 2 is then pushed backward toward the movable joint 13, thereby freeing the hooks 16 from the locks 21. In order to free the hooks 16 from the locks 2, it is necessary to push the speaker unit 2 with a force exceeding a frictional force between the locks 21 and the hooks 16.

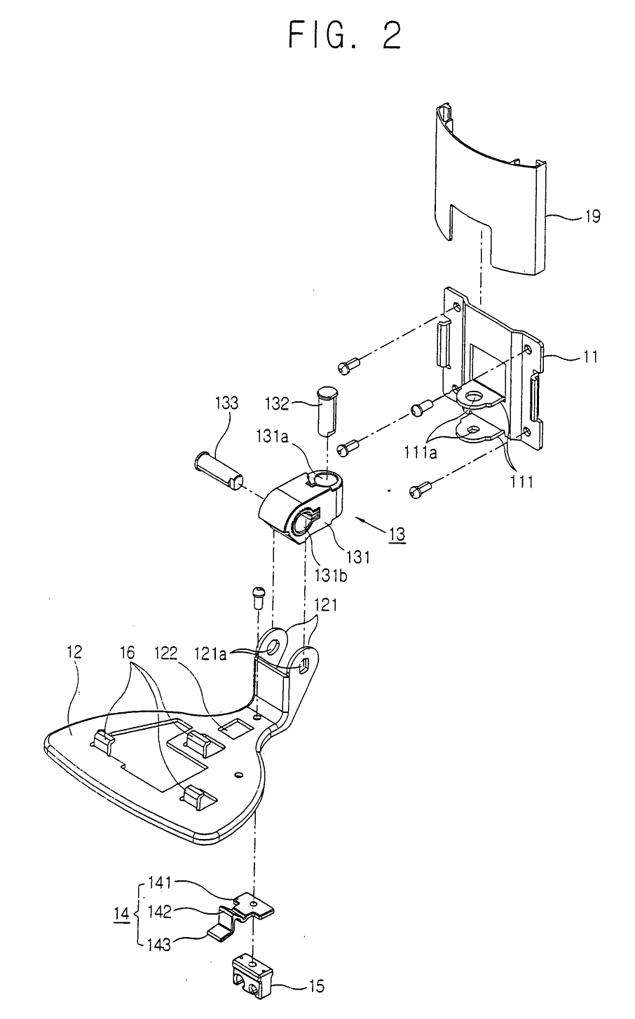

As shown in FIG. 2, the cable clip 15, disposed under the supporter 12, holds the power supply cable (not shown) for the speaker unit 2.

According to the present invention, the swiveling shaft 132 and the tilting shaft 133 are coupled to the stationary member 11 and the supporter 12 respectively, but these combinations may be changed as necessary.

As described above, according to the present invention, the wall mounting speaker assembly provides a simple and screw-free assembly and/or disassembly of the speaker unit 2 and the supporter 12, and enables the supporter to be swiveled and tilted.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A wall mounting speaker assembly having a speaker unit, comprising:
a stationary member mounted on a wall;
a supporter to support the speaker unit;
a movable joint, provided between the stationary member and the supporter, and coupled to a vertical swiveling shaft and a horizontal tilting shaft, thereby allowing the speaker unit to swivel and tilt;
a lock provided on a bottom of the speaker unit; and
a hook provided on the supporter to be engaged with the lock, preventing the speaker unit from moving upward from the supporter.

2. The speaker assembly according to claim 1, wherein the hook cooperates with the lock of the speaker unit having been slid frontward along the supporter.

3. The speaker assembly according to claim 2, further comprising a stopper, at the supporter, to prevent a release of the speaker unit.

4. The speaker assembly according to claim 3, further comprising a stopper groove to accommodate the stopper therein, wherein the stopper groove is concave at a bottom of the speaker unit, to accommodate the stopper therein.

5. The speaker assembly according to claim 3, further comprising a stopper through hole formed in the supporter, and
the stopper includes: a flat part attached to the backside of the supporter; a holding part protruding upward to penetrate the hole; and a release part forcing the stopper to move downward and to make the salient lock in a release mode.

6. The speaker assembly according to claim 1, further comprising a cable clip, provided under the supporter, to hold a power supply cable for the speaker unit.

7. The speaker assembly according to claim 2, further comprising a cable clip, provided under the supporter, to hold a power supply cable for the speaker unit.

8. The speaker assembly according to claim 3, further comprising a cable clip, provided under the supporter, to hold a power supply cable for the speaker unit.

9. The speaker assembly according to claim 4, further comprising a cable clip, provided under the supporter, to hold a power supply cable for the speaker unit.

10. The speaker assembly according to claim 5, further comprising a cable clip, provided under the supporter, to hold a power supply cable for the speaker unit.

11. A wall mounted speaker assembly, to mount a speaker, having locks and a groove, comprising:
a stationary member having a first bracket;
a joint member, coupled to the stationary member via a first shaft, which is held in place by the first bracket, to rotate about the first shaft;
a supporter having hooks to cooperate with the locks of the speaker and a second bracket, coupled to the joint member via a second shaft, which is held in place by the second bracket, to rotate about the second shaft; and
a stopper, to cooperate with the groove to prevent the speaker from being unintentionally released from the supporter when the locks cooperate with the hooks.

12. The speaker assembly according to claim 11, wherein the locks protrude from a bottom surface of the speaker.

13. The speaker assembly according to claim 12, wherein the groove is located in the bottom surface of the speaker.

14. The speaker assembly according to claim 11, wherein the first bracket comprises a hole through which the first shaft is inserted.

15. The speaker assembly according to claim 11, wherein the supporter comprises:
a plate having an upper surface, which contacts the speaker, from which the hooks extend, and a lower surface; and
a hole through which the stopper penetrates.

16. The speaker assembly according to claim 15, wherein the stopper comprises:
a flat part fixed on the lower surface of the supporter;
a holding part penetrating the hole in the supporter; and
a release part to force the holding part to retreat from the hole in the supporting part when pulled externally.

17. The speaker assembly according to claim 11, wherein the second bracket comprises a hole through which the second shaft is inserted.

18. The speaker assembly according to claim 11, wherein the first and second shafts extend through joint member holes in first and second directions.

19. The speaker assembly according to claim 18, wherein the first and second directions are perpendicular.

20. A method of assembling a wall mounted speaker assembly, including a stationary member, a joint member to rotate around the stationary member, a supporter, having a flat surface from which hooks, with hooking surfaces, extend and a hole, to rotate around the joint member, a speaker having locks, with locking surfaces, to engage with the hooks and a groove, and a stopper to penetrate the hole in the supporting unit and cooperate with the groove, the method comprising:
engaging the hooks of the supporter with the locks of the speaker;
locking the speaker in place after the hooks are engaged with the locks via the cooperation between the stopper and the groove;
positioning the speaker by rotating the supporter around the joint member and by rotating the joint member around the stationary member.

21. The method according to claim 20, wherein the engaging comprises:
positioning the locking surfaces to abut the hooking surfaces; and
pulling the speaker frontward from the stationary member along the supporter.

22. The method according to claim 21, further comprising disassembling the speaker from the wall mounted assembly.
